(19) United States
(12) Patent Application Publication
(10) Pub. No.: US 2024/0162772 A1
(43) Pub. Date: May 16, 2024

(54) ROTOR AND METHOD FOR PRODUCING THE ROTOR

(71) Applicant: ebm-papst Mulfingen GmbH & Co. KG, Mulfingen (DE)

(72) Inventors: Johannes VOHMANN, Mulfingen (DE); Michael RUETTLER, Weikersheim (DE); Andre HEMMANN, Obrigheim (DE)

(21) Appl. No.: 18/509,817

(22) Filed: Nov. 15, 2023

(30) Foreign Application Priority Data
Nov. 16, 2022 (DE) 10 2022 130 321.7

(51) Int. Cl. H02K 1/30

(52) U.S. Cl. CPC H02K 1/30

(57) ABSTRACT

A rotor (10) with a rotor pot (1), a hub (2) and a shaft (3) are provided,
wherein the rotor pot (1), the hub (2) and the shaft (3) are rotatable about an axis of rotation (A) of the rotor (10).

The shaft (3) is accommodated in a hub bushing (21) of the hub (2) to form a shaft-hub connection.

The rotor pot (1) has a receptacle (11) for the hub (2) and the hub (2) is secured to the rotor pot (1) at least in the region of the receptacle (11).

An edge portion (111) of the receptacle (11) of the rotor pot (1) extends at least partially parallel to the axis of rotation (A).

A method is also provided for producing the rotor (10).

### BACKGROUND

### Field

The invention relates to a rotor with a rotor pot, a hub and a shaft. The invention further relates to a method for producing the rotor.

### Description of Related Art

A variety of shaft-hub connections to a rotor pot of rotors is known from the prior art. For the shaft-hub connection, a metallic connection, a direct connection of the shaft to the yoke of the rotor pot, metallic inserts of an ESM variant or, in the case of an application for low speeds, a shaft-hub connection made of plastics are usually used.

A disadvantage of these solutions is that the shaft-hub connection provides too little support for the shaft for a corresponding application. Moreover, radial forces are not sufficiently transmitted to the rotor. In the case of a shaft-hub connection made of plastics, it can also occur that the plastic lifts off from the yoke to an undesirable extent.

SUMMARY

It is therefore the object of the invention to overcome the above-mentioned disadvantages and to provide a rotor and a method for producing the rotor, in which supporting the shaft and transmitting the radial forces into the yoke are optimized.

This object is achieved by the combination of features according to claim 1.

According to an example embodiment of the invention, a rotor with a rotor pot, a hub and a shaft is proposed, in which the rotor pot, the hub and the shaft are rotatable about an axis of rotation of the rotor. Here, the shaft is accommodated in a hub bushing of the hub to form a shaft-hub connection. The rotor pot has a receptacle for the hub and the hub is secured to the rotor pot at least in the region of the receptacle. In particular, the rotor pot and the shaft are overmolded, preferably with a plastic material, to form the hub. Furthermore, an edge portion of the receptacle of the rotor pot extends at least partially parallel or angled to the axis of rotation.

The advantage of this is that by supporting the shaft with the aid of the edge portion of the rotor pot receptacle, which extends at least partially parallel or angled to the axis of rotation, the rigidity of the shaft-hub connection and of the rotor base of the rotor pot is increased. In this context, angled or at an angle to the axis of rotation is to be understood to mean in particular that the corresponding angle between the edge portion of the receptacle of the rotor pot and the axis of rotation is 0° to 75°, preferably 0° to 45°, more preferably 0° to 25°.

In a preferred embodiment of the invention, the edge portion of the receptacle extends parallel to the axis of rotation. In particular, the receptacle is cylindrical in shape. In this manner, the strength of the shaft-hub connection and the support of the shaft are optimized.

In an advantageous embodiment variant, it is provided that the rotor pot comprises an accommodation space for an electric motor. In this case, the edge portion extends into the accommodation space. As a result, a space required for the rotor is reduced and transmitting the axial forces acting on the shaft-hub connection into the rotor pot is improved.

Preferably, the rotor is designed in such a manner that the shaft has a portion with a knurl, in particular a cross knurl, and/or grooves, which portion is accommodated in the hub bushing. The knurl and the grooves transmit the radial forces via the hub to the rotor pot or optimize the transmission.

In one embodiment variant, the rotor according to the invention is designed in such a manner that the hub is made of plastics and is injection-molded at least onto the receptacle by means of an injection molding process. Furthermore, an embodiment is favorable in which the rotor pot and in particular the shaft are made of a metallic material.

In one exemplary embodiment of the invention, it is provided that at least one recess is formed in the receptacle, which is arranged adjacent to the edge portion. In this case, the hub extends through the at least one recess. The recess is in particular punched and reduces lifting of a hub made of plastics between the rotor pot and the overmold. In a preferred embodiment, a multiplicity of recesses is formed in the rotor pot, preferably five recesses. In an advantageous embodiment, the corresponding recesses are arranged symmetrically, in particular on a circular path, around the edge portion. The advantage of this is that imbalance of the rotor is reduced or as low as possible.

In another exemplary embodiment, it is provided that a multiplicity of recesses are formed in the receptacle, which are arranged distributed in the circumferential direction of the receptacle. In this manner, lifting off the hub from the rotor pot is further reduced.

Furthermore, an example embodiment is favorable in which the at least one recess is arranged in a portion of the rotor pot which extends in a radial direction with respect to the axis of rotation. Preferably, the recess is arranged directly adjacent to the edge portion of the receptacle extending at least partially parallel to the axis of rotation.

In one embodiment variant of the invention, it is provided that the hub completely encloses the receptacle. In this case, it is advantageous that lifting off the hub from the rotor pot is further reduced and the support of the shaft is additionally improved.

In one exemplary embodiment, the rotor according to the invention is designed such that the rotor pot is formed, at least in sections, as a yoke ring.

In one embodiment variant of the invention, it is further provided that an outer peripheral surface of the rotor pot is completely surrounded by the hub and/or the fan wheel.

According to an example embodiment of the invention, it is further proposed to provide a fan having a fan wheel and a rotor according to the above disclosure. In one exemplary embodiment of the fan according to the invention, the hub is formed in one piece and/or integrally with the fan wheel.

Furthermore, according to an example embodiment of the invention, a method for producing a rotor according to the above disclosure is proposed, in which firstly a deep-drawing of the rotor pot in the region of the receptacle is carried out in such a manner that the edge portion of the receptacle of the rotor pot extends at least partially parallel to the axis of rotation. Subsequently, at least one recess is punched in the receptacle adjacent to the edge portion. Thereafter, the rotor pot is overmolded at least in the region of the receptacle and the recess. In doing so, the hub is formed and, in particular, the receptacle is completely overmolded and the recess is at least partially overmolded. In addition, when the rotor pot is overmolded to form the shaft-hub connection, a portion of the shaft, in particular the portion of the shaft with the knurl and/or the grooves, is overmolded. Alternatively, insertion of the shaft into the hub bushing is carried out after overmolding.

In one exemplary embodiment of the method, the shaft is pre-positioned in the recess in a predetermined manner prior to overmolding.

The features disclosed above can be combined as desired, insofar as this is technically possible and they do not contradict each other.

### BRIEF DESCRIPTION OF THE DRAWINGS

Other advantageous further developments of the invention are characterized in the subclaims or are illustrated in more detail below together with the description of the preferred embodiment of the invention with reference to the figures. In the figures:

FIG. 1 shows a sectional view of a fan with a rotor.

The figures are schematic by way of example. Identical reference signs in the figures indicate identical functional and/or structural features.

### DETAILED DESCRIPTION OF ILLUSTRATIVE EMBODIMENTS

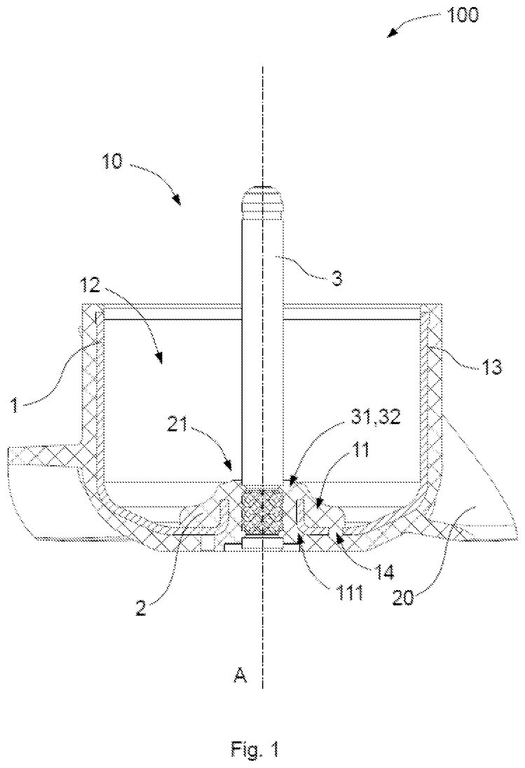

In FIG. 1, a sectional view of a fan 100 with a fan wheel 20 and a rotor 10 is illustrated. The rotor 10 comprises a rotor pot 1, a hub 2, and a shaft 3. Further, the hub 2 is formed integrally with the fan wheel 20.

The rotor pot 1, the hub 2, and the shaft 3 are rotatable about an axis of rotation A of the rotor 10. In addition, the shaft 3 is accommodated in a hub bushing 21 of the hub 2 to form a shaft-hub connection. The rotor pot 1 has a receptacle 11 for the hub 2, and the hub 2 is secured to the rotor pot 1 at least in the region of the receptacle 11. In this case, an edge portion 111 of the receptacle 11 of the rotor pot 1 extends parallel to the axis of rotation A. Furthermore, the rotor pot 1 comprises an accommodation space 12 for an electric motor and the edge portion 111 extends into the accommodation space 12. The hub 2 completely encloses the accommodation space 11.

Furthermore, the hub 2 is made of plastics and is molded to the receptacle 11 by means of an injection molding process. The rotor pot 1 is made of a metallic material. The shaft 3 has a portion with a cross knurl 31 and grooves 32, which portion is accommodated in the hub bushing 21.

In the rotor 10 of the fan 100 shown in FIG. 1, a multiplicity of recesses 14 are formed in the receptacle 11, which recesses are distributed in the circumferential direction of the receptacle 11 and are arranged adjacent to the edge portion 111. In this case, the hub 2 extends through the recesses 14. Furthermore, the recesses 14 are arranged in a portion of the rotor pot 1 which extends in a radial direction with respect to the axis of rotation A.

Moreover, the rotor pot 1 is formed, at least in sections, as a yoke ring, and an outer peripheral surface 13 of the rotor pot 1 is completely surrounded by the hub 2 and/or the fan wheel 20. Furthermore, a projection of the hub 2 and/or the fan wheel 20 extends radially with respect to the axis of rotation A over an axial end of the rotor pot 1.

The invention is not limited in its embodiment to the preferred exemplary embodiments indicated above. Rather, a number of variants which make use of the solution shown even in fundamentally different embodiments is conceivable.

1. A rotor (10) with a rotor pot (1), a hub (2) and a shaft (3),
wherein the rotor pot (1), the hub (2) and the shaft (3) are rotatable about an axis of rotation (A) of the rotor (10),
wherein the shaft (3) is accommodated in a hub bushing (21) of the hub (2) to form a shaft-hub connection,
wherein the rotor pot (1) has a receptacle (11) for the hub (2) and the hub (2) is secured to the rotor pot (1) at least in the region of the receptacle (11),
wherein an edge portion (111) of the receptacle (11) of the rotor pot (1) extends at least partially parallel or angled to the axis of rotation (A), and
wherein at least one recess (14) is formed in the receptacle (11), which recess is located adjacent to the edge portion (111), wherein the hub (2) extends through the at least one recess (14).

2. The rotor (10) according to claim 1, wherein the edge portion (111) of the receptacle (11) extends parallel to the axis of rotation (A).

3. The rotor (10) according to claim 1, wherein the rotor pot (1) comprises an accommodation space (12) for an electric motor, wherein the edge portion (111) extends into the accommodation space (12).

4. The rotor (10) according to claim 1, wherein the shaft (3) has a portion with a knurl (31) and/or grooves (32), which portion is accommodated in the hub bushing (21).

5. (canceled)

6. The rotor (10) according to claim 1, wherein a multiplicity of recesses (14) is formed in the receptacle (11), which recesses are arranged distributed in the circumferential direction of the receptacle (11).

7. The rotor (10) according to claim 1, wherein the at least one recess (14) is arranged in a portion of the rotor pot (1), which portion extends in a radial direction with respect to the axis of rotation (A).

8. The rotor (10) according to claim 1, wherein the hub (2) completely encloses the receptacle (11).

9. The rotor (10) according to claim 1, wherein the hub (2) is made of a plastics and is injection-molded at least onto the receptacle (11) by means of an injection molding process.

10. The rotor (10) according to claim 1, wherein the rotor pot (1) is made of a metallic material.

11. The rotor (10) according to claim 1, wherein the rotor pot (1) is formed, at least in sections, as a yoke ring.

12. The rotor (10) according claim 1, wherein an outer peripheral surface (13) of the rotor pot (1) is completely surrounded by the hub (2) and/or thea fan wheel (20).

13. A fan (100) with a fan wheel (20) and a rotor (10) according to claim 1, wherein in particular the hub (2) is formed integrally with the fan wheel (20).

14. A method for producing a rotor (10) according claim 1, comprising the steps of:
a. deep-drawing the rotor pot (1) in the region of the receptacle (11) in such a manner that the edge portion (111) of the receptacle (11) of the rotor pot (1) extends at least partially parallel to the axis of rotation (A);
b. punching at least one recess (14) in the receptacle (11) adjacent to the edge portion (111);
c. overmolding the rotor pot (1) at least in the region of the receptacle (11) and the recess (14), wherein the hub (2) and in particular a fan wheel (20) is formed integrally with the hub (2), wherein in particular the receptacle (11) is completely overmolded and the recess (14) is at least partially overmolded;
d. inserting the shaft (3) into the hub bushing (21) or overmolding a portion of the shaft (3), in particular the portion of the shaft (3) with the knurl (31) and/or the grooves (32), when overmolding the rotor pot (1) to form the shaft-hub connection.

15. The method according to claim 14, wherein the shaft (3) is pre-positioned in a predetermined manner in the recess (14) before overmolding.
